(19) United States
(12) Patent Application Publication
(10) Pub. No.: US 2017/0061500 A1
(43) Pub. Date: Mar. 2, 2017

(54) SYSTEMS AND METHODS FOR DATA SERVICE PLATFORM

(71) Applicant: BORODIN RESEARCH INC., TORONTO (CA)

(72) Inventor: TALIA BORODIN, TORONTO (CA)

(21) Appl. No.: 15/254,349

(22) Filed: Sep. 1, 2016

Related U.S. Application Data
(60) Provisional application No. 62/213,377, filed on Sep. 2, 2015.

(51) Int. Cl. G06Q 30/02; G06F 17/30; G06N 99/00; G06Q 30/06

(52) U.S. Cl. CPC G06Q 30/0273; G06Q 30/0631; G06F 17/30563; G06N 99/005

(57) ABSTRACT

A computer-network implemented method performed by a processor of a data services platform is provided. The method comprising: receiving raw data from a plurality of disparate sources over a communications network; applying an extract-transform-load (ETL) process to raw data to obtain processed data; storing processed data in a master repository data store; applying, by a data analytics engine, machine learning analysis based on one or more sets of rules to the processed data in the master repository data store; and generating one or more prediction values based on the machine learning analysis.

### CROSS REFERENCE TO RELATED APPLICATIONS

This application claims the benefit of U.S. Provisional Application No. 62/213,377, filed on Sep. 2, 2015, the contents of which are hereby incorporated by reference in their entirety.

### FIELD

The embodiments disclosed herein generally relate to the field of data collection and analytics, and more particularly to systems and methods for collecting or synthesizing advertising data. Such data may be used in a wide capacity beyond advertising alone.

### INTRODUCTION

Various companies promote and sell a wide range of products and/or services. Promotion and advertising of the products and services involve various marketing activities, including placing advertisements online, recommending goods or services on social media, targeting groups of potential consumers with specific promotional offers, planning and carrying out marketing campaigns both in the digital universe and the real world.

The massive shift from traditional to digital marketing has resulted in a significant increase in available content and data available to advertisers. For example, ad units (such as display advertising) are routinely offered for sale or for auction by digital firms, where marketers or brand managers may purchase the ad units based on specific goals.

Online advertising, for example, may leverage the use of audience segmentation tools to target specific consumers using for example demographic criteria. It may be standard practice at digital giants like Google™ and Facebook™ to allow marketers to A/B test two versions of advertisements to determine relative effectiveness, and it is becoming increasingly common for these firms to offer both multivariate testing as well as segmentation analysis of the testing.

In computing, the term “cold start” may refer to the problem of inferring patterns or behaviours for users and items when insufficient data is available for data modeling. This is one common data mining problem and affects virtually all predictive modeling, such as the modeling applied to advertising data. The lack of sufficient data which defines the cold start problems requires the collection of data or assumptions to supplement existing processes and proposed processes.

A number of options are currently available to aid researchers in developing cold start methodologies, such as subject matter expert interference, collaborative filtering, or appending of external data. However, existing technologies have various drawbacks. For example, subject matter expert interference tends to be time consuming and costly, collaborative filtering requires a large pool of data, without which the generated predictions may be weak, and appending external data may run into issues with various privacy laws, and data availability may vary significantly by geography or jurisdiction.

### SUMMARY

In one example embodiment, a computer-network implemented method performed by a processor of a data services platform is provided. The method may include: receiving raw data from a plurality of disparate sources over a communications network; applying an extract-transform-load (ETL) process to the raw data to obtain processed data; storing the processed data in a master repository data store; applying, by a data analytics engine, machine learning analysis based on one or more sets of rules to the processed data in the master repository data store; and generating one or more prediction values based on the machine learning analysis.

In one aspect, the raw data may include at least one of: targeting data, individual user data, metrics data and advertisement metadata.

In another aspect, the method may include generating, and displaying by way of a digital dashboard, one or more recommendations based on the one or more prediction values.

In yet another aspect, the one or more recommendations may relate to at least one of: target audience, target demographic characteristics, a delivery method of advertisements, advertisement content, and product type.

In still another aspect, the method may include receiving requests for purchase of advertisements and generating customized recommendations, based on the one or more prediction values, in response to the requests for purchase of advertisements.

In a further aspect, the method may include collecting or synthesizing advertising data for use beyond the advertising.

In still a further aspect, the data may be used for one or more of the following: new membership or customer acquisition, lead generation, mailing/phone/e-mail list creation, and processing by recommendation engines.

In another example embodiment, a computer-implemented system for providing a data services platform is provided. The system may include: an extract-transform-load (ETL) process utility configured to process raw data from a plurality of disparate sources over a communications network; a master repository data store configured to store the processed data; a data analytics engine configured to apply machine learning analysis based on one or more sets of rules to the processed data in the master repository data store; and a prediction engine configured to generating one or more prediction values based on the machine learning analysis.

In one aspect, the raw data contains insufficient or inadequate user data for a target audience, and the data analytics engine is configured to analyze the processed data in order to determine additional insights into user references for said target audience.

In another aspect, the data analytics engine is configured to apply a fuzzy matching process to determine the additional sights based on the process data.

In yet another aspect, the raw data contains insufficient or inadequate user data for determining product or item recommendations for one or more users or customers, and the data analytics engine is configured to analyze the processed data in order to determine the product or item recommendations.

In a further aspect, the data services platform may be a behavioural data services platform for analyzing or processing user behaviour data.

### BRIEF DESCRIPTION OF THE FIGURES

In the drawings, embodiments of the present disclosure are illustrated by way of example. It is to be expressly understood that the description and drawings are only for the purpose of illustration and as an aid to understanding, and are not intended as a definition of the limits of the present disclosure.

Embodiments will now be described, by way of example only, with reference to the attached figures, wherein:

FIG. 1 provides a block schematic of an example digital advertising system;

FIG. 2 provides a workflow diagram of a process performed by the data service platform in FIG. 1, according to some example embodiments;

FIG. 3 is an illustrative diagram providing generic computer hardware and software for implementation of certain aspects, as detailed in the description;

FIG. 4 illustrates an example three way market-place;

FIG. 5 illustrates an example high level overview of data product;

FIG. 6A illustrates an example high level overview of success metrics;

FIG. 6B illustrates example normalizing metrics;

FIG. 7 illustrates example overview of types of data in a master database;

FIG. 8A illustrates example overview of advertisement metadata;

FIG. 8B illustrates example overview of individual data;

FIG. 8C illustrates example overview of targeting universe data;

FIG. 8D illustrates example overview of success metrics and KPIs associated with ads;

FIG. 9 illustrates example overview of an ETL process on raw data in master database;

FIG. 10A illustrates example data mining operations by a data analytics engine;

FIG. 10B illustrates example data mining test results;

FIG. 11 illustrates a block diagram of a data service platform in accordance with one example embodiment;

FIG. 12 illustrates an example individual view of cold start dashboard;

FIG. 13A illustrates an example cold start dashboard-batch processing;

FIG. 13B illustrates an example executive cold start dashboard;

FIG. 14 illustrates an example overview of advertisement targeting via a dashboard;

FIG. 15 illustrates an example directional targeting overview via a dashboard;

FIG. 16A illustrates an example matching process; and

FIG. 16B illustrates an example data inference in matching process.

### DETAILED DESCRIPTION

The embodiments of the devices, systems, methods, processes described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

In the context of computerized implementation, there are several technologies that provide tools that may be beneficial to the marketing of goods or services. For example, digital giants such as Google™ and Facebook™ allow marketers to A/B test two versions of advertisements to determine a relative effectiveness, and it is becoming increasingly common for these firms to offer both multivariate testing as well as segmentation analysis of the testing.

Across the world, social networks are becoming an increasingly popular medium for socializing and self-expression, as well as for seeking better lifestyle or products through peer-recommendation or validation. Social networks are also becoming an effective tool for business learning, sales and networking. As a result of this popularity, certain social networks such as Facebook™ and LinkedIn™ have millions and millions of users.

Traditional data vendors tend to work off a very similar pool of data that is a collection of consumer data, predictive models and census, purchasing of such data has limited benefit to the above-mentioned problem of “cold start”. Disclosed herein are embodiments designed to address the “cold start” problem, and to offer additional benefits and insights into ad content, audience targeting as well as data product offering with utility far beyond the advertising use case.

Embodiments disclosed herein may provide a data service platform or system that delivers learned insights regarding potential or existing users, as determined by collecting and synthesizing a variety of data such as digital advertising data. The insights may form the foundations upon which recommendations for product, content, communication method may be based. Such insights may provide visibility into efficacy of ad units or ad inventories relative to a target audience, and in turn provide support for improved targeting techniques for new ads and promotional campaigns.

A plurality of decision support systems or utilities (e.g. dashboard engine) may be provided to utilize the data analytics or the insights, and to provide digital dashboards based on results or recommendations computed based on a plurality of prediction values. For example, data engines and dashboards may be utilized to plan and implement advertising or marketing campaigns. Likewise the data and insights can be used in a variety of ways outside the marketing world. Examples include but are not limited to: new membership, customer acquisition, lead generation, mailing/phone/email list creation, recommendation engines, and so on.

In some embodiments, the platform may be configured to provide various features, such as, but not limited to the provisioning and/or display of one or more data repositories of user or content (e.g. ad unit) preferences; the creation, distribution, placement and/or tracking of advertisements; dashboards for ad advertisers (e.g. marketers or brand managers) or other stakeholders to view various data analytics; decision support systems responsive to various real-time or near real-time data updates. The decision support utility (e.g. dashboard engine) may make recommendations, such as best delivery method of advertisements for a specific age group, or most likely target audience for a video advocating for environmental protection, or a demographic group to which one should target to promote certain kind of gym memberships, and so on. In some embodiments, decision support functionality may aid in the identification and/or discovery of marketing campaign objectives and/or leading practices.

In various embodiments, the platform may provide one or more dashboards for decision support, where administrators and/or advertisers may be able to receive various suggestions or recommendations from the dashboards as determined by a data engine (such as a prediction and/or a dashboard engine) based on a set of rules, and these suggestions may vary depending on the objectives, target audience, product/service type, etc. from the advertisers' requirements or goals. The decision support may, in some embodiments, provide feedback in relation with industry averages and/or any other type of available success or business metrics.

In one aspect, the target audience may comprise one or more users, one or more potential customers, or one or more products.

In some embodiments, there is provided a digital advertising system is disclosed. Said digital advertising system may generate learned insights regarding new, existing or potential users, which may be determined based on observational data sourced from traditionally distinct and disparate sources. The observational data may be obtained through placement and monitoring of digital advertisements. The observational data may include performance metrics, success metrics or business metrics associated with one or more types of advertising content or type. The observational data may be normalized or otherwise processed and further stored in at least one data store. The digital advertising system may include a data services platform.

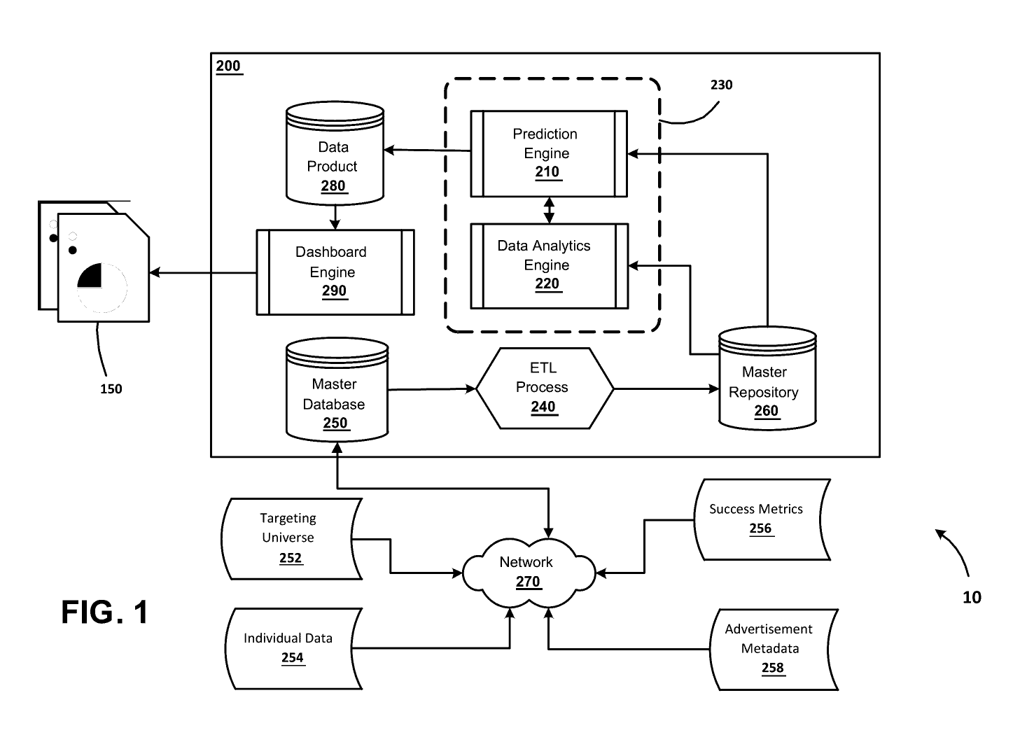

Referring first to FIG. 1, which provides a block schematic of a digital advertising system 10. Digital advertising system 10 may comprise data service platform 200, according to some example embodiments. The platform 200 may comprise a master repository 260, data engines 230 such as prediction engine 210 and data analytics engine 220, data product 280 and a dashboard engine 290. The platform 200 may further include optional master database 250 and an ETL process 240.

In one embodiment, the ETL process 240 may be provided by an ETL process utility. In another embodiment, the ETL process 240 may be provided by a suitable module connected to or implemented as part of any one of the data engines 210, 220 and 230.

The platform 200 may be comprised of one or more servers having one or more processors, operating in conjunction with one or more computer-readable storage media, configured to provide backend services, such as data processing, data storage, data backup, data hosting, among others. Each of these subsystems may be implemented using one or more modules comprising instruction sets executed on one or more processors.

Network 270 may be any type of network, including, but not limited to, the internet, various intranets, wireless connections, wired connections, etc.

The data engine subsystem 230, which may include a data analytics engine 220 for data mining, and a prediction engine 210 for generating prediction values, may be configured to provide analytical capabilities based upon data stored in master repository 260. The data engine subsystem 230 may, in some embodiments, be configured to provide functionality for decision support, through, for example, analyzing key performance indicators (KPIs) from one or more successful advertisements online in contrast to less successful advertisements.

In some embodiments, decision support may include machine learning for the extraction and/or identification of relevant data, providing decision support responsive to the type of parameters of a marketing or ad campaign (e.g., target geography or demographic, product/service type, campaign objectives), or decision support compared against industry leaders and/or metrics.

There may be an additional rules engine (not shown) configured to enable the definition, deletion, modification, application, and/or monitoring of one or more rules. The one or more rules may constitute various elements of logic, and may also provide one or more triggers based on the occurrence/non-occurrence of various events. For example, the rules may be designed or updated based on various analytical reports and prediction models to determine which ads were most effective.

The data storage 250, 260, 280 may include various types of non-transitory computer readable media, and may, in some embodiments, be a distributed networking implementation, such as a cloud computing implementation. The data storage may include various types of databases and/or storage media, such as Hadoop, SQL servers, flat files, Microsoft Excel™ files, etc. Information may be stored as records and may, in some embodiments, have one or more relationships defined between various records. In some embodiments, the data storage may preprocess and/or transform, extract or load the data for data mining and/or data warehousing purposes.

Master database 250 may include a variety of raw data from a plurality of disparate data sources. The raw data may include targeting universe data 252, individual user data 254, success metrics or KPI data 256, and advertisement metadata 258, as non-limiting examples.

Master repository 260 may include processed data after a non-trivial Extract-Transform-Load (ETL) process 240 has been performed on the raw data from master database 250.

Data product 280 may store prediction values or results that may be further leveraged by a dashboard engine 290 to generate recommendations or other types of data for dashboards 150.

The dashboard engine 290 may be configured to provide one or more user interfaces to one or more users. The interfaces may be provided through network 270. The dashboard engine 290 may, in some embodiments, interoperate with one or more external systems (not shown) through the platform in providing interfaces to users. For example, the engine 290 may be configured to provide various dashboards 150. The dashboard engine 290 may further be configured to allow users to interact with the platform 200 by providing various elements of information, such as the ability to log into the platform 200 to view current marketing or ad offers, to select targeting audiences, to check efficacies of placed ads on various social media platforms, and so on.

In some embodiments, the platform 200 may include e-commerce functionalities configured to enable potential purchasers of ads to review and purchase advertisements, and to select target audience and ad content accordingly. Occasionally, said selection of target audience or ad content may be dependent on one or more recommendations generated by dashboard engine 290, as described further below.

For example, disclosed herein is a computer-network implemented process 300 configured to acquire data through the use of digital advertising. For another example, a three-way marketplace may be configured through which said digital advertising may be facilitated and monitored over a communication network 270.

In one example embodiment, the may be provided a platform for 200 collecting and synthesizing data via digital advertising to be used both as a solution to the cold start problem and/or to serve as a standalone data platform as well as to provide enhanced targeting capabilities. This embodiment may be applicable to virtually all industries.

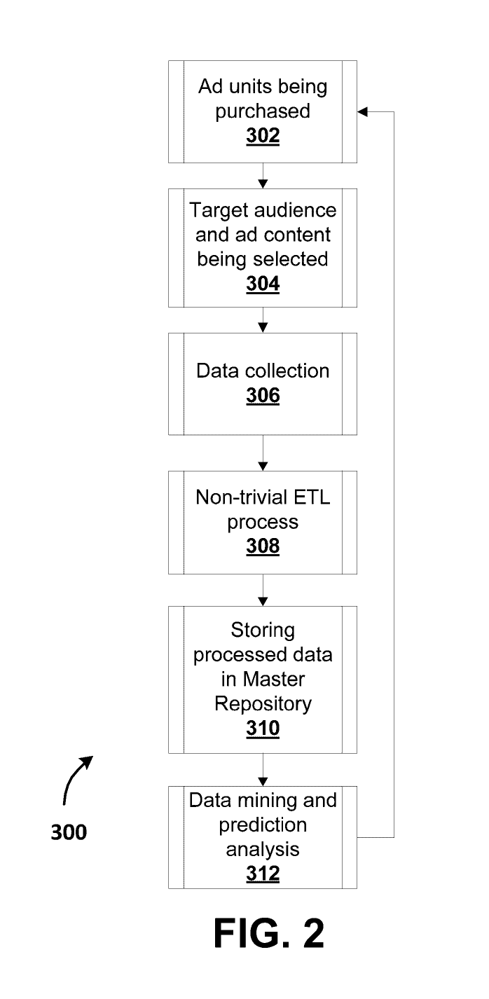

In accordance with another aspect, a process 300 for collecting, synthesizing and mining data is provided. Referring now to FIGS. 1 and 2, at block 302, enterprises or organizations may purchase digital advertisement units (“ad units”). For example, the ad units may be purchased at a discounted rate in exchange for their data to be used in data mining and predictive analysis. In one embodiment, the ad units may be purchased by way of a three-way marketplace, as further elaborated below. Once organizations have chosen the desired target audience and content types at block 304, they may purchase ads outright, or use A/B or multivariate test ads in order to determine the best content for the target audience.

In one embodiment, the disparate data sources may comprise raw data such as advertisement metadata 258, individual user data 254, targeting universe data 252, and/or success metric data 256. Some or all of the raw data may be collected over a communication network 207 at block 306 and optionally stored in a master database 250. The collected raw data may contain different data formats or different data standards.

Next, a non-trivial ETL (extract, transform and load) process 240 at block 308 may be utilized to process the collected data from the disparate sources 252, 254, 256 and 258. For example, the ETL process 240 may normalize the collected data and store the normalized data in a master repository 260. In some instances, the data may be synthesised and/or ranked based on a weight. In some instances, raw metrics such as a number of purchases attributed to the advertisement may be converted to more predictive values, such as a likelihood (e.g. a probability value) of a purchase given a specific action has occurred as a result of the respective advertisement.

The types of data collected and processed may vary. For example, behaviour or observational data may be collected and processed. For another example, various success or performance metric data may be collected and processed. The processed data may be further aggregated at individual and/or group levels.

Post-ETL process, a master repository 260 at block 310 may be generated or updated to include the ETL-processed data. The master repository 260 may then be mined, at block 312, in accordance with one or more sets of rules, by a data analytics engine 220. The one or more set of rules may be determined and refined by way of machine learning. Additional weighting and ranking steps may be performed by the data analytics engine 220 to further refine the results. A prediction engine 210 may in turn extrapolate or otherwise generate prediction results, such as predictive values, at individual user or group levels, where the prediction results may be stored in a data product 280 and may be further leveraged by a dashboard engine 290 to generate dashboards 150.

Various attributes of advertisements may be logged as they are executed, and may be stored to database 250. The data analytics engine 220 may receive the information and/or may be configured to enable analysis of advertisements, for example, to analyze performance. In some embodiments, the engines 210, 220, 230 may be configured to utilize various machine learning techniques, such as neural networks, hidden Markov models, etc. to discover trends and/or parameters of ads and target audiences.

In one embodiment, the data product 280 may be further utilized by the advertisers or brand managers in the next round of purchase of ad units, where the prediction results are leveraged to select target audience and/or ad content for maximum efficacy of ads being purchased.

The platform 200 may include one or more utilities that manage the definition, application and/or monitoring of one or more rules. The one or more rules may provide a flexible implementation whereby the one or more rules can be defined to be triggered upon occurrences of various conditions or events, and may lead to one or more actions being taken. For example, rules may be defined to monitor for various variables of ad content and to change various aspects of the ad content accordingly. Similarly, rules may be applied to define and/or dynamically maintain exclusivity and act as a gatekeeper for various functionality accessible to users. For example, rules may be defined so that only a subset of a user's contacts may be eligible for a particular marketing campaign e-mail offer.

Accordingly, by using digital advertising, including A/B and multivariate testing, as means for collecting data rather than strictly for advertising purposes, a master repository 260 may be created and mined to generate learned insights and to make recommendations based on specific demands. Predictions created in the above process may then be sold and delivered as a stand-alone product 280 for individuals looking for data appends in any industry, regardless of their online advertising capabilities. Thus a cost neutral data product 280 may be generated by the process. This data product 280 may be based on observational data rather than self-report data, which tends to be more unreliable.

In one aspect, as explained herein, the platform 200 may incorporate various planning or decision support tools, such as dashboards, that are configured to generate recommendations for placement and purchase of ad units, or to plan marketing campaigns. The platform may also provide help advertisers to find and reach the target audience, and to mount effective marketing campaigns.

In another aspect, the platform 200 may be further configured to recognize additional factors that may affect the efficacy of digital advertisements, in addition to target audience demographics. The additional factors may be particularly important or relevant when there is a “cold start” problem, where the advertisers do not have access to sufficient preference data for one or more target audience, or to determine one or more item or product recommendations. For example, for new customers without a transaction history, it would be difficult to make recommendations based on a blank browsing or purchase history. However, said additional factors, as generated by a dashboard engine 290, may assist with making a product or advertisement recommendation for the new customers. Such additional factors may include a response rate associated with the content or media in which the ad is placed, medium through which the advertisement is delivered or broadcast (e.g. banners in an e-mail or message through a video streaming service provider), or recognized devices of the customer (e.g. an iPhone™ or Android™ tablet).

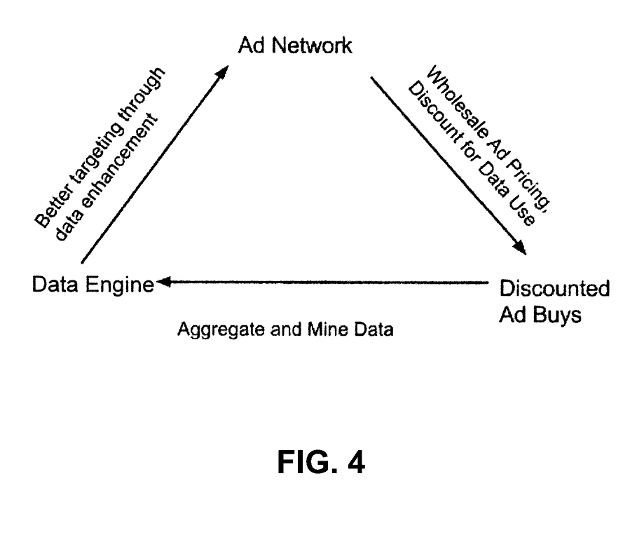

In some embodiments, a data collection process may start with an advertising purchase. Organizations can purchase digital advertising across all major networks via a number of digital advertising aggregators or directly. A three-way market place (see e.g. FIG. 4) may provide access to these networks via a discounted rate given in exchange for allowing their data to be used in predictive modeling by platform 200. This discounted rate may be paid for by batch purchasing and/or advertising partnerships thus making the data collection process self-funded. A given organization's data may not be released on its own, however an aggregation of inferences across organizations and platforms may be allowable under terms of the agreement. As the master database 250 and master repository 260 grows, so does the predictive power and flexibility of the data product offerings 290.

Once organizations have chosen the desired target audience and content types they may purchase ads outright, or choose AB or multivariate test ads in order to determine the best content for the target audience. Raw data 252, 254, 256 and 258 may be collected over network 270 across disparate sources accordingly based on a monitoring of the purchased ads or the test ads. From here, a non-trivial ETL process 240 may be applied to make use of the collected raw data 252, 254, 256 and 258 in a non-standard format.

The ETL process 240 may involve standardizing the raw data stored in master database 250. Such raw data have different data formats or standards. For example, different digital advertising content may have different success metrics. For example, the success of a video advertisement is typically defined by whether or not the user watches the majority of the video prior to skipping. In email and banner ads, the definition of success can vary from something as simple as a click to something much more actionable such as eventual purchase.

In addition, a number of success metrics and/or KPIs 256 may be synthesized and ranked according to the effort required on the part of the user. For example, a purchase may require considerable more commitment from the part of the user than a click. The relationship between various KPI's may be estimated and routinely re-estimated based on latest data.

In addition to multiple performance metrics (KPIs), the level of granularity of results may also vary significantly across digital platforms. Some vendors such as Google™ may have extremely strict privacy laws, and will only release data at relatively high aggregate level whereas other forms of digital advertising is available at the user (cookie) level, with many levels in between. Therefore, some embodiments include a layering of aggregate and individual data across the various performance metrics, thereby creating a master repository 260 of both individual and group level characteristics.

The next step may be to mine the results of the digital advertising buying. In the simple example of a traditional A/B test where two advertisements are testing against one another for the same target audience, users/items may be labelled either by binary classification symbols (e.g. success/non-success, click/no click, etc. . . . ) or by continuous variables representing scalar performance metrics (% of video watched, $ donation amount, and so on.).

In some embodiments, data from master repository 260 may be mined by data analytic engine 220 and further processed by prediction engine 210 to make predictions on the best issues or types of content on all major success metrics to give added flexibility. For example, an organization with a banner ad for a new product will only be interested in results where data has been restricted to banner ads for similar products. On the other hand, a client with a defined target and no completed content may want to look at mined preferences of users in the same or a similar target group.

In one example embodiment, predictions created in the above process can then be sold and delivered as a stand-alone product (e.g. data product 280) for individuals looking for data appends in any industry, regardless of their online advertising capabilities. Thus a cost neutral data product 280 may be generated by the invention. This data product 280 is based on observational data rather than self-reported data which tends to be more unreliable.

In one example embodiment, the described process is configured to leverage the billions of dollars spent annually on digital advertising to create a data product offering based on the combination of techniques from across industry, platforms and sources in the manners described herein.

In another example embodiment, mining of hypothesis tests by a data analytics engine 220 can be used to determine which subgroups under or over perform for a particular variation of a website. A challenge in mining A/B test data is that a substantial amount of data is required to make any reasonable inferences and only a minority of organizations have large enough customer/membership bases to do this. To overcome this challenge, a large pool of data across organizations is required. Digital advertising may be one of the cheapest methods of reaching consumers. That plus the ease of purchasing advertising and the finite number of major advertising conglomerates (hence finite number of output files) facilitates a crowd sourced observational data engine (e.g. data analytics engine 220) with access to a wide range of digital advertising data across disparate sources. Since advertising conglomerates are distinctly different entities than traditional consumer data providers. The cost-neutral process may allow for easy feasibility and scaling.

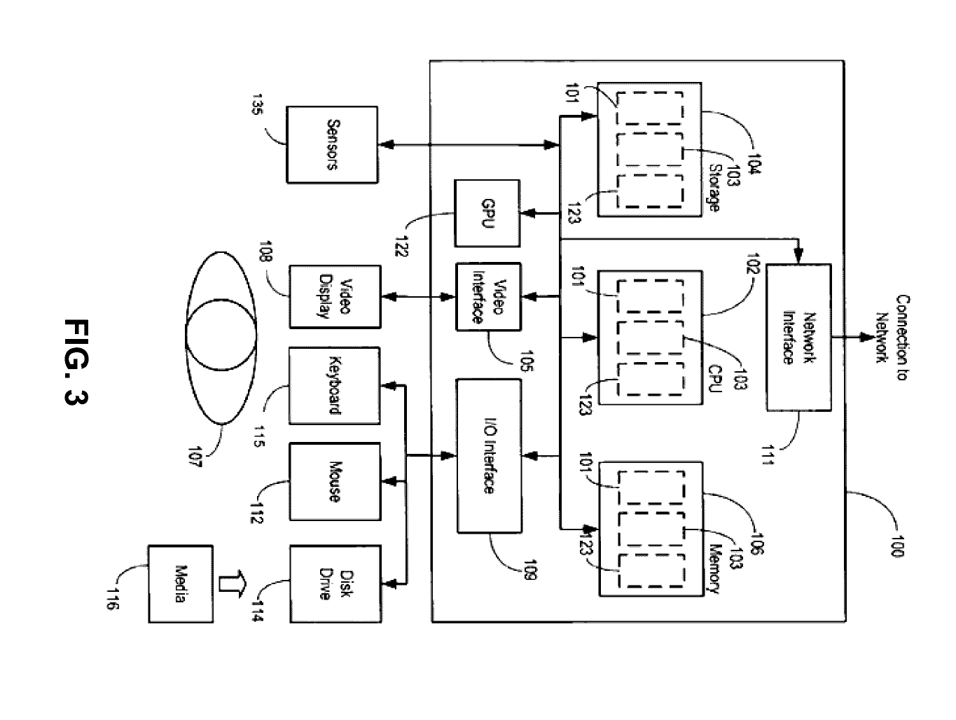

The systems and methods described herein may be practiced in various embodiments. A suitably configured computer device, and associated communications networks, devices, software and firmware may provide a platform for enabling one or more embodiments as described above. By way of example, FIG. 3 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

Computing device 100 is operable to register and authenticate users (using a login, unique identifier, and password for example) prior to providing access to applications, a local network, network resources, other networks and network security devices. Computing devices 100 may serve one user or multiple users.

FIG. 4 illustrates an example three way market-place. In one embodiment, the three way market-place works by discounting ad buys through wholesale buying and data usage agreement. From there, the data may be mined, by a data services platform 200 including one or more data engines 210, 220, 230 as described herein, to provide an aggregated user/item view (e.g. via a dashboard), for re-sale as well as to provide enhanced targeting capabilities for ad buyers.

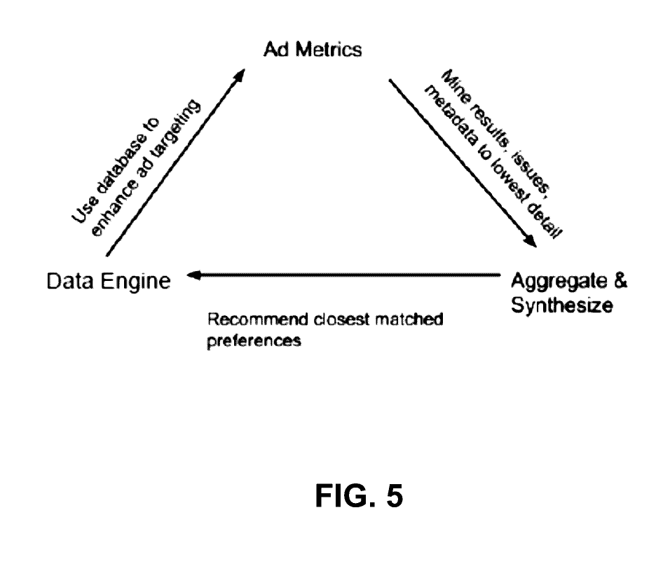

FIG. 5 illustrates an example high level over view of data product. The data product can be an aggregate of mined data from ad buys and matched to targets by proximity. Matched and anonymized data can be sold for cold start or used to targeting purposes in future advertising campaigns.

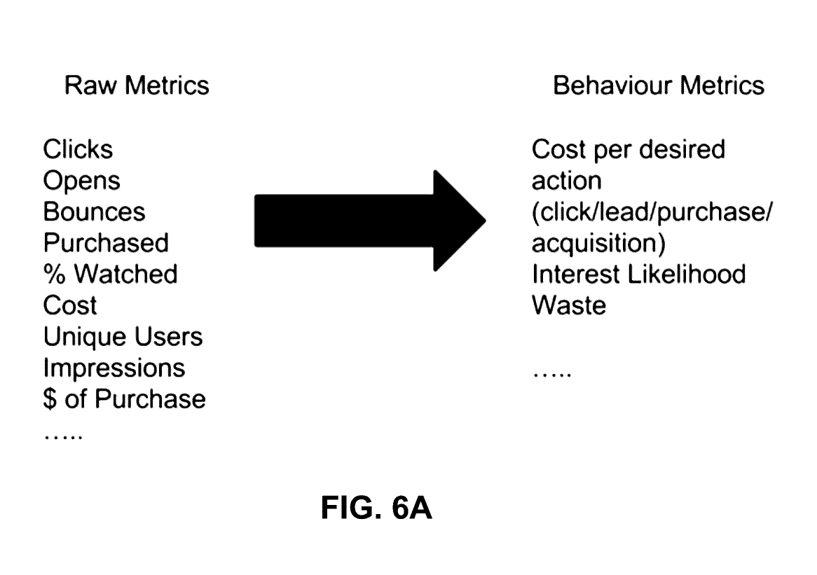

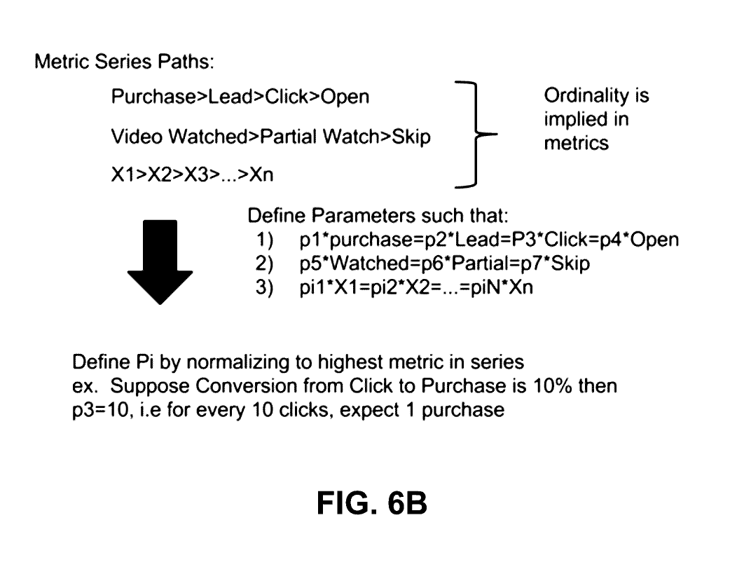

FIG. 6A illustrates an example high level overview of success metrics. High level overview of sample raw data including advertising output metrics is shown, with corresponding processed behaviour based metrics, as generated by an ETL process 240.

As can be seen, sample raw metrics returned by most online advertisers include clicks, opens, bounces, purchases, percentage of watched (videos), cost, unique users, impressions amount of purchases, and so on. The raw metric data may then be transformed to be used for data modeling. In one embodiment, the ETL process 240 may conduct part or all of the modeling effort, the bulk of which includes manipulating data to put the data into appropriate forms. In this case, raw metrics like the number of purchases attributed to the advertisement may be converted to more predictive values such as “probability of purchase given a specific action has occurred”, i.e. probability of purchasing given user has viewed a video, probability of purchasing given user has viewed a view related to x, and so on.

FIG. 6B illustrates example normalizing metrics and their associated classes. In order to leverage all types of raw digital data, paths for each unique type may be defined, such that various metrics that fall under that path, may be normalized. In order to leverage all of the data, relationships may be created to link as many metrics as possible. This is because some advertisers may only provide metric A while others provide metric B, and without a relationship between A and B, it may be difficult to link those metrics to create a uniform dataset. As illustrated in this FIG. 6B, classes of KPI's may be formed based on a type of advertisement. From there, parameters may be estimated such that β1*KPI1=β2*KPI2=β3*KPI3. That is, instead of having dozens of unrelated KPI's, there may be a handful of KPI classes related to a type of advertisement from which there will be one standard metric applied through use of standardization function described herein.

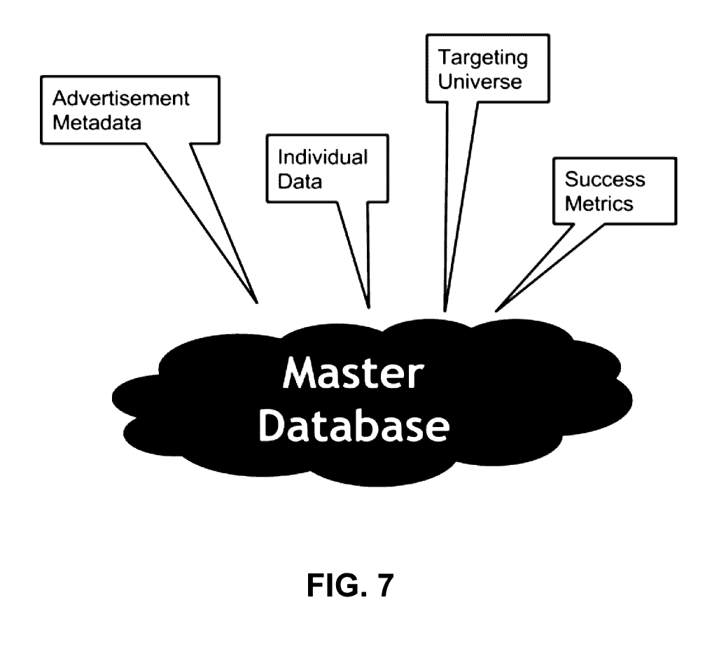

FIG. 7 illustrates example overview of types of raw data in a master database 250. The raw data may include targeting universe data 252, individual user data 254, success metrics or KPI data 256, and advertisement metadata 258, as non-limiting examples.

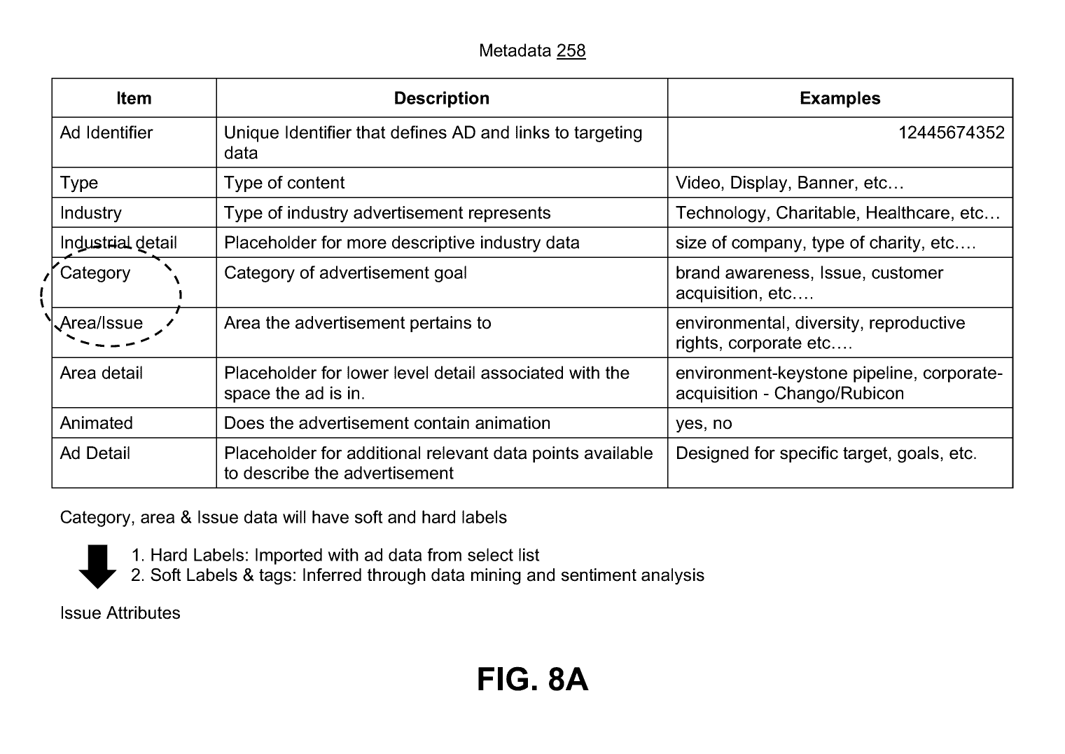

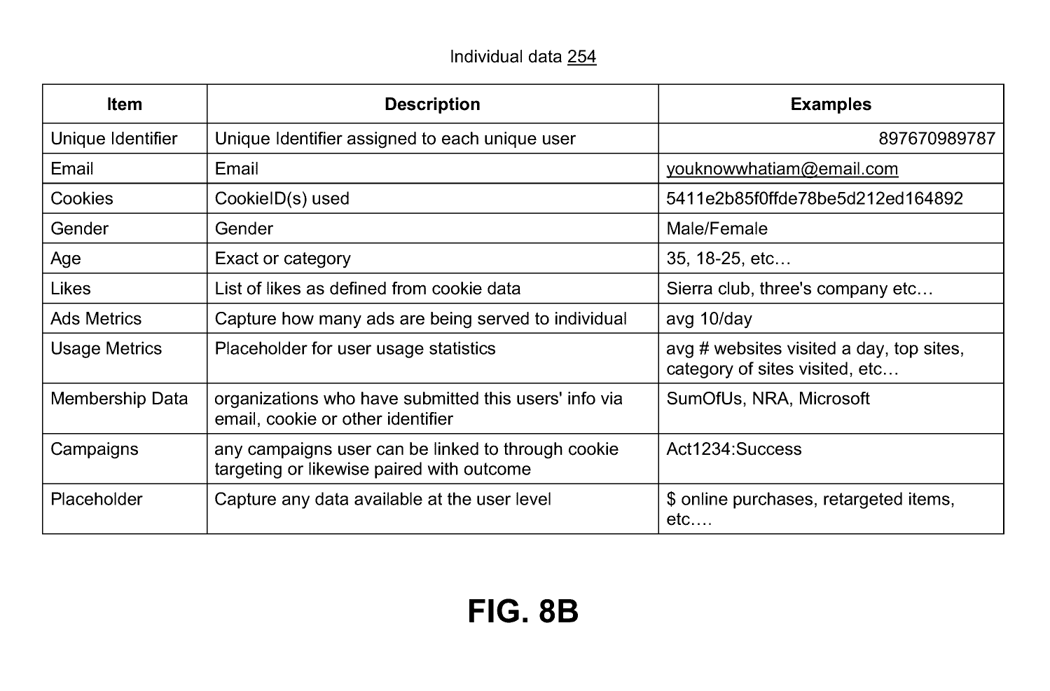

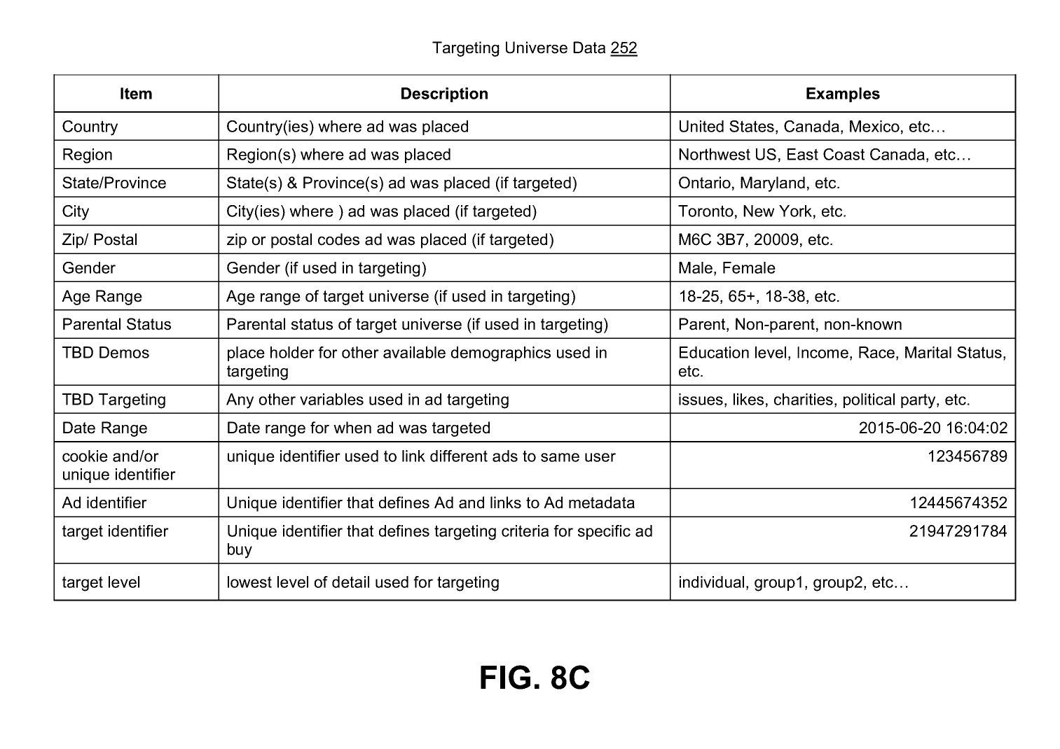

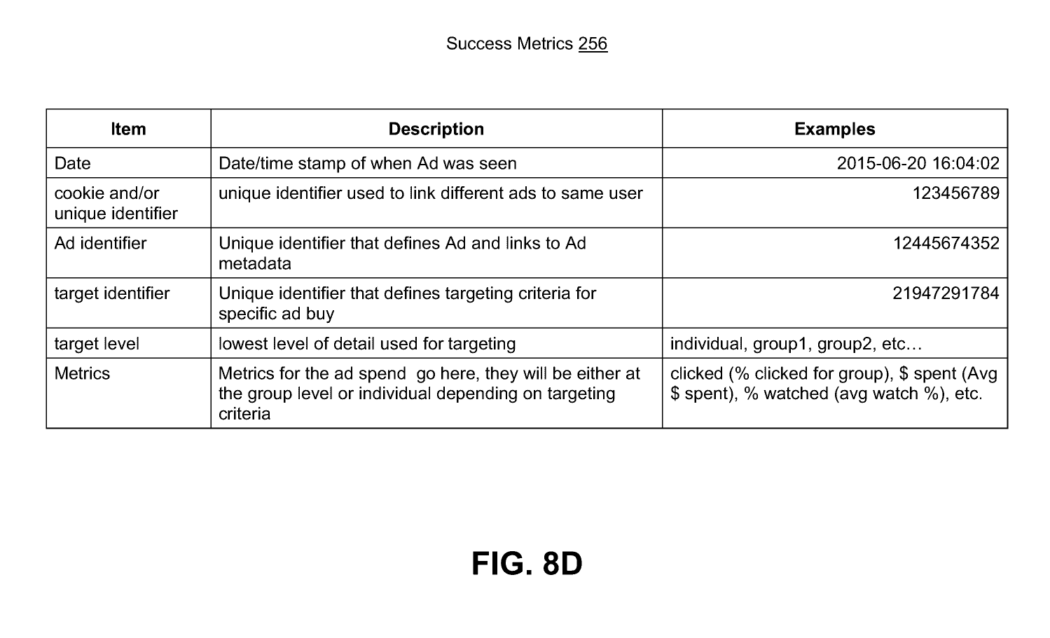

FIG. 8A illustrates example overview of advertisement metadata 258. This may include high level overview of types of data collected from advertisers regarding their ads. For example, advertisement metadata may refer to data that describes a particular advertisement. For example, the advertisement may be a video, image or text. The subject area of the advertisement may be for instance women's shoes. Specifications related to these parameters may also be collected, such as font size, font type, pixel size of image, length of video, and so on, which can be used to observe user preferences.

FIG. 8B illustrates example overview of individual data 254. For example, various types of user data may be captured on the individual level if cookie/email matching or likewise is available. For example, raw data relating to unique identifier, email, cookies, gender, age, likes, ads metrics, usage metrics, membership data, campaigns may be collected. In one embodiment, individual data 254 may refer to any data that is available at the user or item level. For users, such details may include demographics such as age and gender (if available) as well as proprietary data such as memberships, past purchases, customer cohort, and so on. A similar process can be extrapolated for item based individual level data such as sales to date, key features, and so on.

FIG. 8C illustrates example overview of targeting universe data 252. For example, targeting universe data may include raw data relating to country, region, state/province, city, zip/postal, gender, age range, parental status, tbd demos, tbd targeting, date range, cookie and/or unique identifier, ad identifier, target identifier, target level and so on. These types of data that can be used to target digital media buys. Capturing targeting universe data used in advertising targeting (for example: ad target was 30-40 year old single women) facilitates further fulfillment of master database 250. Once sufficient data has been collected, ecological inference or another suitable machine learning technique can be used to make individual level data predictions to supplement the overall data available. For example, suppose user 123 has viewed 3 ads within the following three targeting universes: a) Single women under 40; b) Women over 30; and c) IT professionals. It may then be assumed with some reasonable degree of accuracy that user 123 is a single women between 30 and 40 who works as an IT professional, which may help with future target audiences and ad content.

FIG. 8D illustrates example overview of success metrics and KPIs 256 associated with ads. For example, as shown, there may be one row per ad, per lowest level of detail available. In one embodiment, individual user/cookie for personal and email targeting, and the lowest granularity advertising performance metrics may be made available by a particular ad provider.

In one example embodiment, success metric may refer to any and all data that will be returned from advertising agent including but not limited to: click through rates, % of video watched, ad closures, and so on. Various vendors may provide this data at different levels of accuracy. In the case of email, data may be returned at the user level (e.g. whether user 123 has clicked the ad link), while most major online advertising channels only provide aggregate data. In each case, all raw data may be collected and labelled to indicate in what level of aggregation the data was received. Additionally, unique identifiers may be added in order to facilitate linking to the advertising and targeting universe databases. In another embodiment, a processed version of metric data 256 may be used as a dependent variable in data models, while the data belonging to the rest of data types may be explanatory variables.

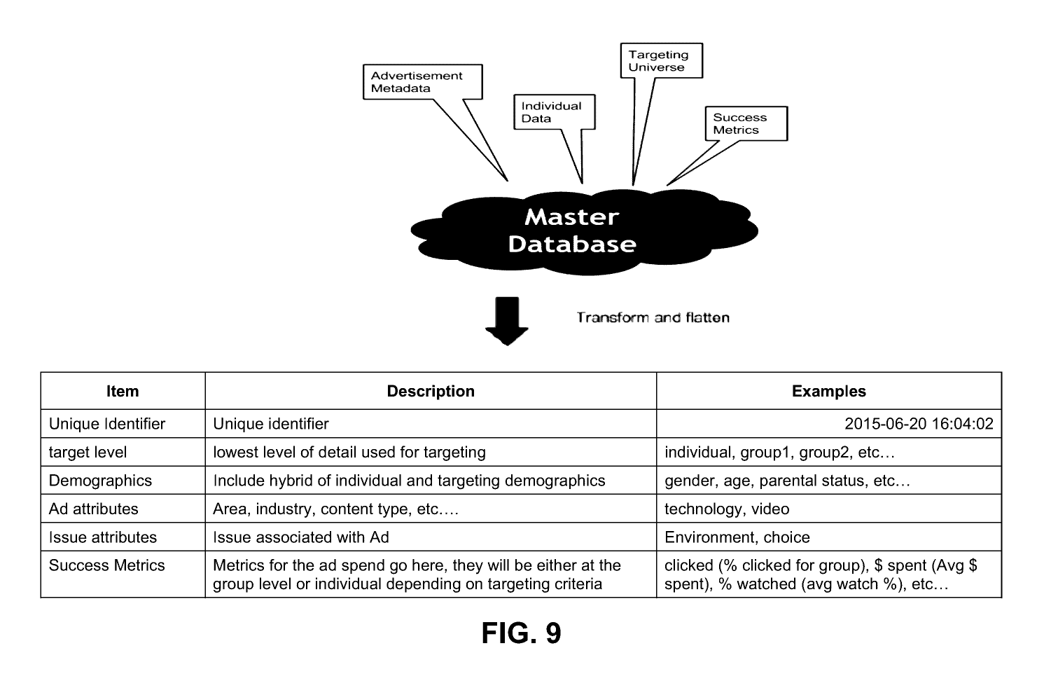

FIG. 9 illustrates example overview of an ETL process 240 performed on raw data in master database 250. FIG. 9 demonstrates how a master repository 260 may be created and updated by collecting and processing raw data 252, 254, 256, 258 from across disparate sources. For example, there may be provided a hybrid approach to demographic data collected from both individual and targeting data stores.

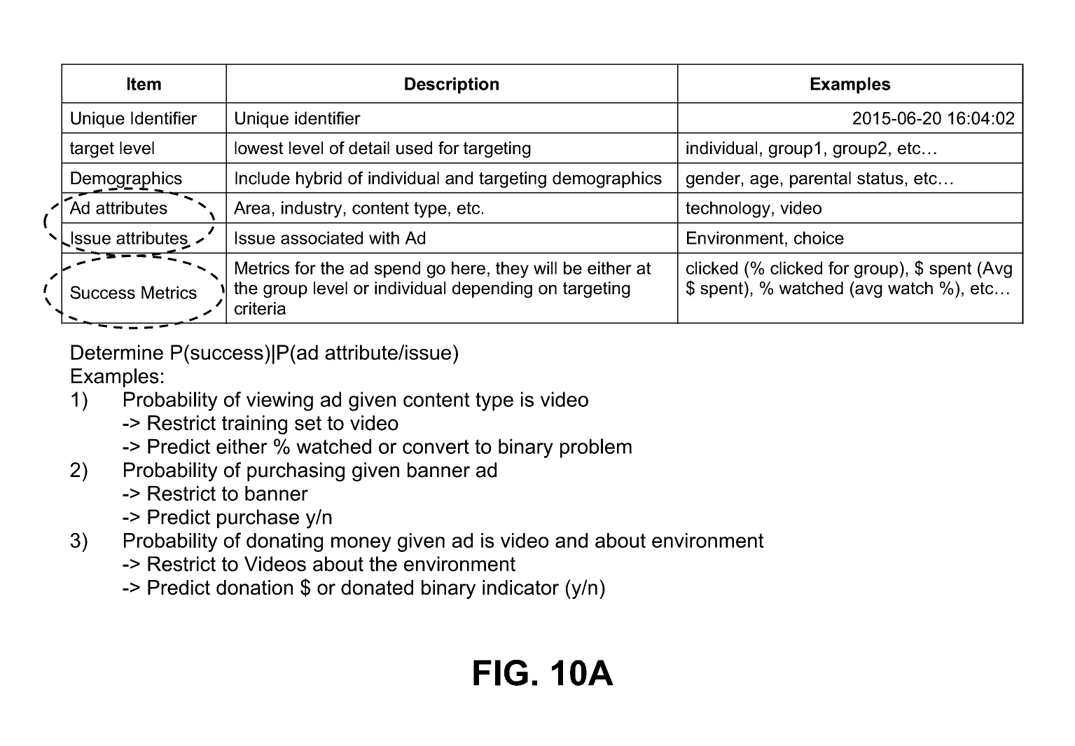

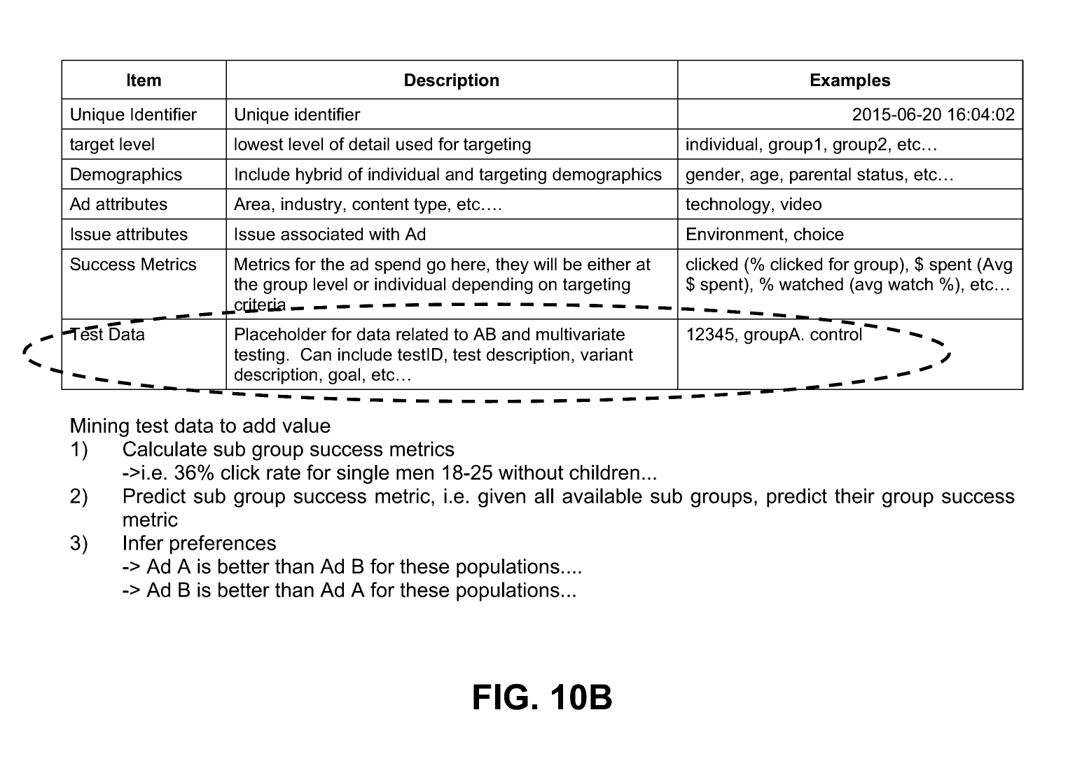

FIG. 10A illustrates example data mining operations by a data analytics engine 220. FIG. 10B illustrates example data mining results, which may include test results for A/B and multivariate tests. To avoid disclosing sensitive data relating to, for example, personal privacy, financial or health information, the master repository 260 may be mined across a number of attributes and issues. As shown in FIG. 10A, local predictions can be made for all sub groups by restricting the training data in various ways to create different types of predictions, several of which are illustrated. It would be desirable to have a prediction for every content type. Using a classification framework, natural subgroups will be formed, each with their own prediction factor. For example: Single women under 35 are X % likely to watch an entire video ad related to the environment compared to Y %, Z %, respectively as compared with other subgroups. For example, in some embodiments, the following probabilities may be determined:

Determine P(success)|P(ad attribute/issue)

### Examples

### 1) Probability of Viewing Ad Given Content Type is Video

-> Restrict training set to video
-> Predict either % watched or convert to binary problem

### 2) Probability of Purchasing Given Banner Ad

-> Restrict to banner
-> Predict purchase y/n

### 3) Probability of Donating Money Given Ad is Video and about Environment

-> Restrict to Videos about the environment
-> Predict donation $ or donated binary indicator (y/n)

From there, FIG. 10B describes how the set of predicted values may be extrapolated at the user level in order to create an ordering of preferences. For example, take John Smith, suppose he is a white male, aged 24, working in technology. John smith would have a multitude of model scores associated with him, some of which may be specific to John Smith, and some as a result of ad targeting (men under 25, tech professionals, etc.). The scores can then be ranked according to probability of taking an action.

In one embodiment, a weighting methodology may be developed for said ranking. For example, it is likely individual predictions are worth “more” than group level predictions. In one embodiment, the initial weighting may be based on logical assumptions from ad experts, then revised over time as more and more data becomes available and allows for explicit value rankings.

As shown in FIG. 10B, the following test data may be tested to add value:

1) Calculate sub group success metrics
->i.e. 36% click rate for single men 18-25 without children . . . .
2) Predict sub group success metric, i.e. given all available sub groups, predict their group success metric
3) Infer preferences
-> Ad A is better than Ad B for these populations . . . .
-> Ad B is better than Ad A for these populations . . . .

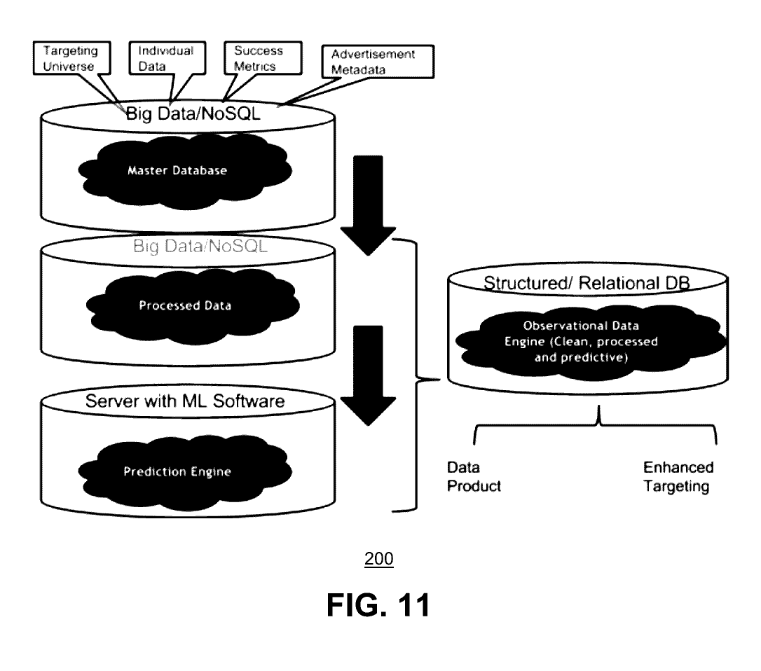

FIG. 11 illustrates a block diagram of a data service platform 200 in accordance with another example embodiment. As shown, raw data 252, 254, 256, 258 may be retrieved from one or more sources or locations, then stored together in the master database 250. The data may then be extracted and transformed by an ETL process 240, which may be configured to clean and normalize the data, and to store the normalized data in master repository 260. The data in master repository 260 may then be used by data engines 210, 220, 230 for mining and making predictions. Master repository 260 may be created from processed data plus predictions, which can serve as both a stand-alone data offering 280 and a targeting engine for future ads via dashboard engine 290.

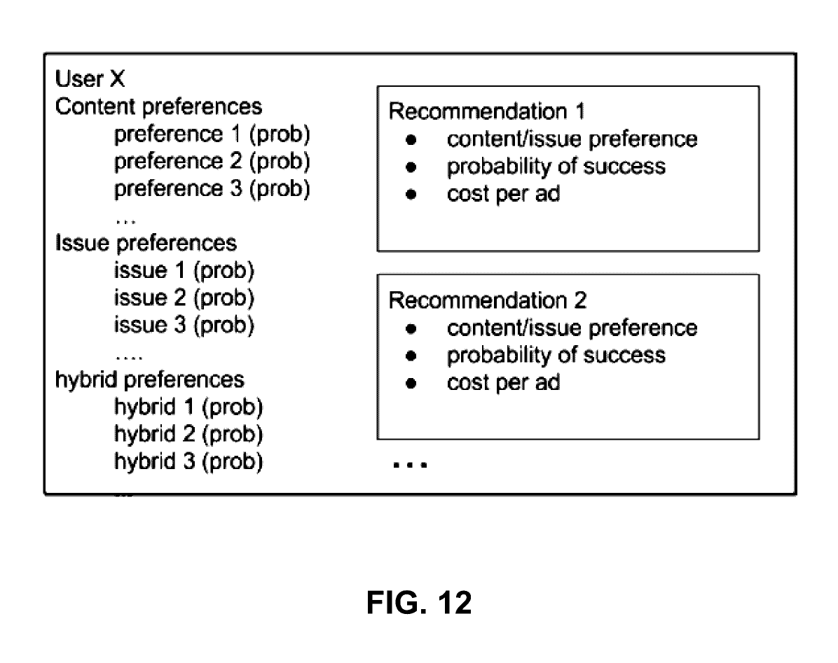

FIG. 12 illustrates an example individual view of a cold start dashboard. Both dashboards as well as bulk extract can contain a user/item level view with recommendations at the lowest possible applicable level of detail.

In one embodiment, a specific example of the cold start problem would be the issue of making product recommendations for new customers who do not have transaction history. In this case, the dashboard engine 290 may seek to make both a recommendation on product as well as a method or manner of contact or delivery. FIG. 12 shows, in one embodiment, the underlying information available at the user level. For each user, there may be a set of preferences pertaining to preferred content type (video, banner ad, etc.) as well as issues (environment, animal rights, etc.). These preferences may be obtained by the data engines as described above, and then a fuzzy matching process may be applied to link individuals to most accurate group level statistics. Once individual preferences are inferred, they may be integrated together into a hybrid preference which can include both preferred delivery method (content prediction), as well as issue/products of most interest to the user.

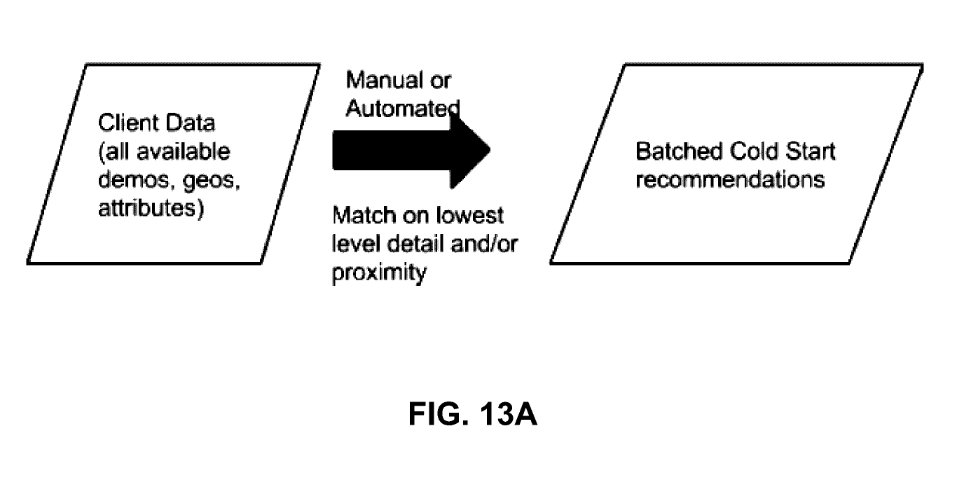

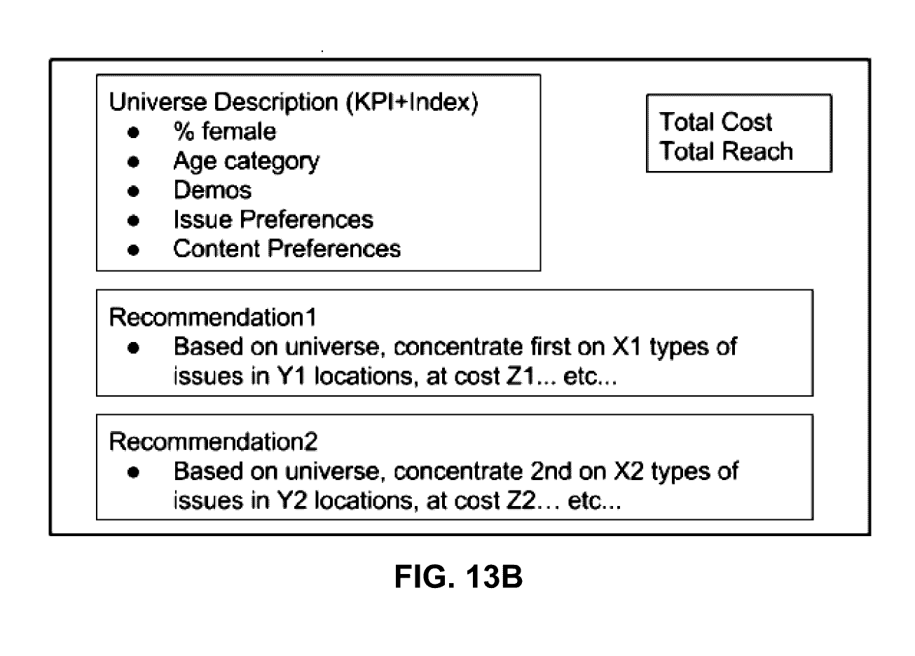

FIG. 13A illustrates an example cold start dashboard-batch processing. In one embodiment, in order to load or use a data product 280, batch processing may be required and may involve bringing in customer files or client data for a match based on one or more of, or a combination of, lowest level detail and proximity. For example, an administrator would access the database via a batch upload where all available data that can be used to match (name, address, email, demographics, zip, etc. . . . ) may be provided. The match may be made at the lowest possible level of detail based on data from a behaviour database, such as a data product 280.

FIG. 13B illustrates an example executive cold start dashboard. In addition to user/item level data which can be available for both viewing and exporting, an executive summary dashboard may be created, in one embodiment, using aggregate highlights from cold start preferences.

FIG. 13B may represent an executive dashboard that summarizes all the recommendations generated by dashboard engine 290. For example, in the cold start problem, suppose the administrator loads a membership list with 50,000 new users containing email, name and age. This list may be matched for users where there is a matching record, and may be matched continuously on higher level data (name and age) iteratively. In one embodiment, a list of each individual recommendation (user 123, emailaddress@email.com, username, age 43) may be assigned one or more preferences in the database based on a user's email address. That user may also be assigned all the preferences of those who are age 43, but this preference may be given lower priority or weight since it is at a group level rather than an individual level. In one embodiment, an executive dashboard which shows summary statistics of the batch import file (average age, % female, % with valid emails, etc. . . . ) plus a list of recommendations and the associated cost and expected reach may be displayed. There are a number of ways recommendations can be assigned at the aggregate level. For example, one way would be to pick the best single recommendation per user and aggregate upwards. Other methods may provide more interesting or nuanced detail, for example, set with an optimization constraint (e.g. set preferences such that the expected margin is improved or even optimal given a specific budget amount).

Another use case would be that of a new customer acquisition. For example, a company or organization may wish to find new customers or members to join. To this end, current customer/membership list may first be uploaded to a dashboard 150 via a batch upload process. This can generate a profile of the best content and ad types for current customer/membership list. Assuming that current customers are good examples of future customers, prediction engine 210 can determine suggestions can be used directly to purchase advertising that will likely appeal most to users similar to the current user base. Alternatively an organization may wish to acquire customers considerably different from than their current base. For example, suppose a charity wants to increase membership amongst minorities. In this case a different dashboard 150 can be needed, one that allows the users to import a list of desired targets (i.e. African American Men between 18 and 30). From there, the appropriate ads can be recommended according to the data in the database 250 available for that demographic group, in a similar fashion to the fuzzy matching described above.

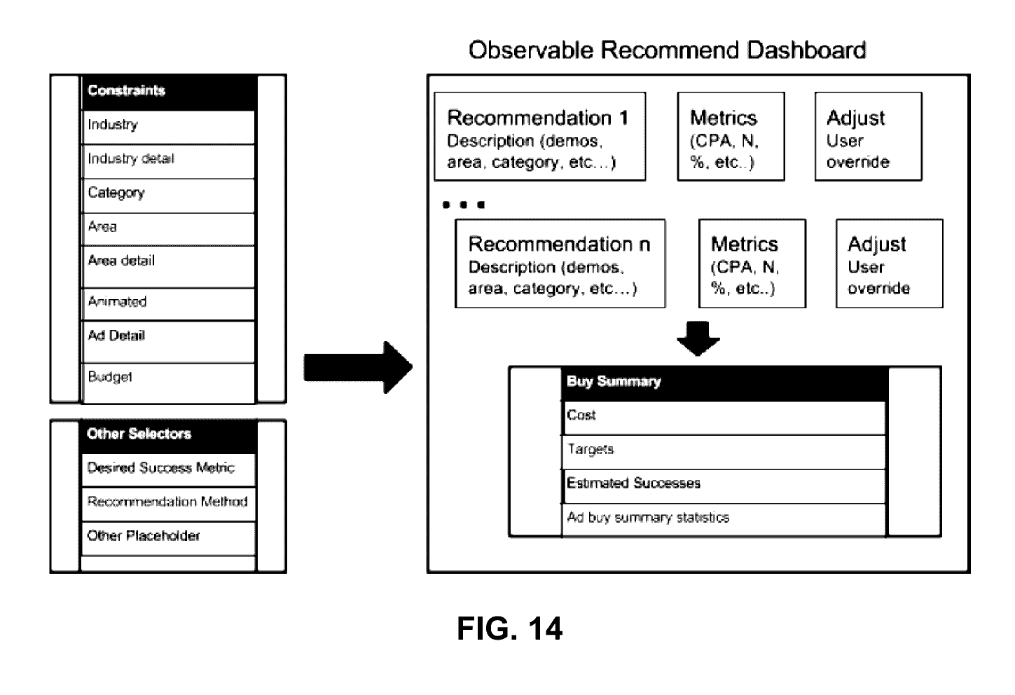

FIG. 14 illustrates another example overview of advertisement targeting via a dashboard.

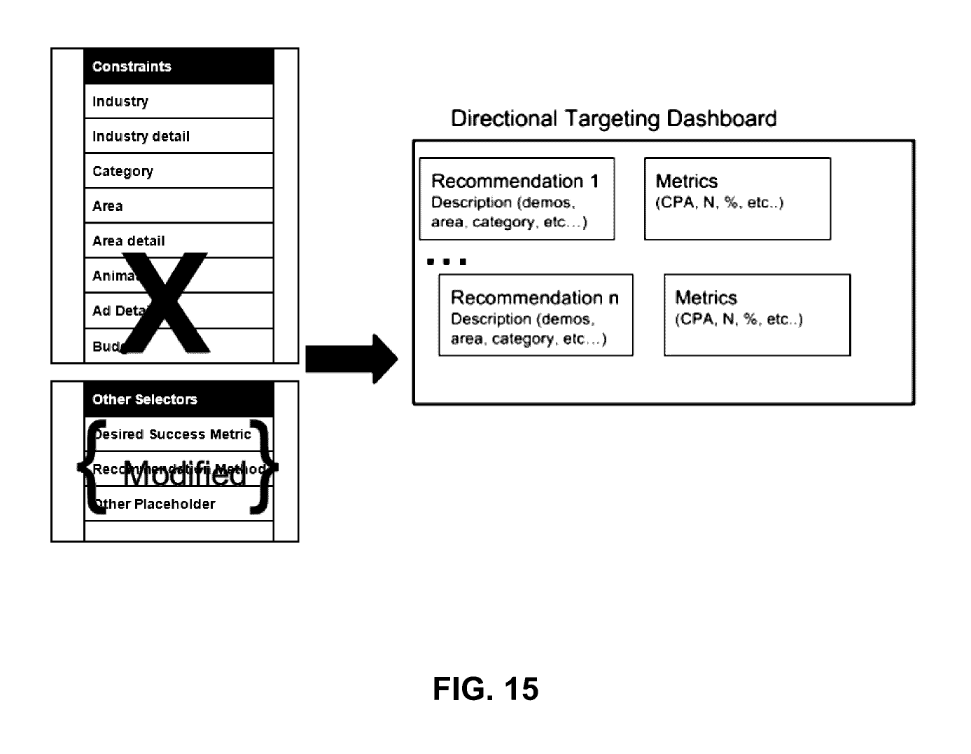

FIG. 15 illustrates an example directional targeting overview via a dashboard. For example, dashboard engine 290 may determine descriptive directional targets to be used for Ad design, offline advertising, customer profiling, and so on.

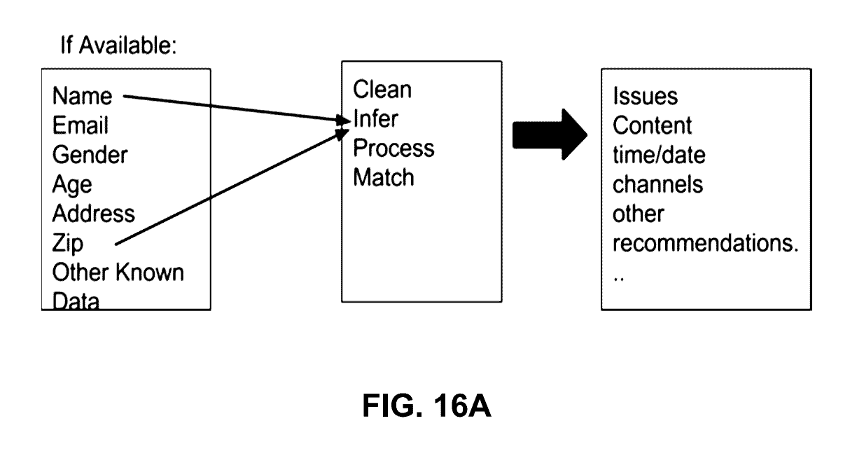

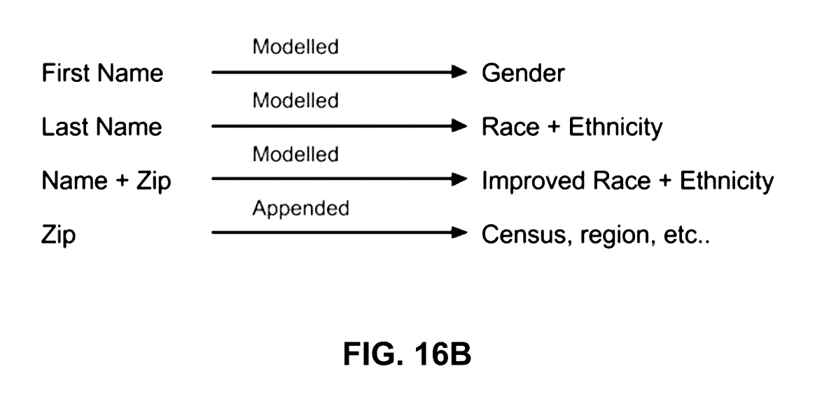

FIG. 16A illustrates an example matching process by dashboard engine 290.

FIG. 16B illustrates an example data inference in matching process. In one embodiment, examples of how missing or unavailable data typically used in matching can be inferred through data mining and data appends.

The present system and method may be practiced on computing devices including a desktop computer, laptop computer, tablet computer or wireless handheld devices having the ability to connect with the Internet and/or various social networking platforms and/or promotional offer inventory systems. In some embodiments, the systems and methods may be performed on distributed networking devices, such as devices arranged in a “cloud computing” implementation.

The computing device components may be connected in various ways including directly coupled, indirectly coupled via a network, and distributed over a wide geographic area and connected via a network (which may be referred to as “cloud computing”).

For example, and without limitation, a computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods and processes described herein.

As will be further understood by those skilled in the relevant arts, significant advantage may be realized through the full or partial automation of any of the processes described above, or portions thereof. Such automation may be provided in any suitable manner, including for example the use of automatic data processors executing suitably-configured, coded, machine-readable instructions using a wide variety of devices, some of which are known and others of which will doubtless be developed hereafter. Processor(s) suitable for use in such implementations can comprise any one or more data processor(s), computer(s), and/or other system(s) or device(s), and necessary or desirable input/output, communications, control, operating system, and other devices or components, including software, that are suitable for accomplishing the purposes described herein. For example, a suitably-programmed general-purpose data processor provided on one or more circuit boards will suffice.

The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation.

It is understood that the terms computer-readable medium or computer useable medium comprises one or more of any type of physical embodiment of the program code. In particular, the computer-readable/useable medium can comprise program code embodied on one or more portable storage articles of manufacture (e.g., an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to various mobile platforms, including the iOS™ platform, ANDROID™, WINDOWS™ or BLACKBERRY™™.

It will be appreciated by those skilled in the art that other variations of the embodiments described herein may also be practiced without departing from the scope of the disclosure. Other modifications are therefore possible.

In further aspects, the disclosure provides systems, devices, methods, and computer programming products, including non-transient machine-readable instruction sets, for use in implementing such methods and enabling the functionality described previously.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or step.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the disclosure, the scope of which is defined by the claims.

What is claimed is:

1. A computer implemented method, the method comprising:
receiving raw data from a plurality of sources over a communications network;
processing the raw data to obtain processed data;
storing the processed data in a data store;
generating one or more prediction values by applying machine learning analysis to the processed data in the master repository data store, wherein the machine learning analysis is based on one or more sets of rules.

2. The method of claim 1, wherein the raw data comprises at least one of: targeting data, individual user data, metrics data and advertisement metadata.

3. The method of claim 1, further comprising displaying a digital dashboard comprising one or more recommendations based on the one or more prediction values.

4. The method of claim 3, wherein the one or more recommendations relate to at least one of: a target audience, target demographic characteristics, a delivery method of advertisements, advertisement content, item, and product type.

5. The method of claim 4, further comprising:
receiving requests for purchase of advertisements; and
generating customized recommendations, based on the one or more prediction values, in response to the requests for purchase of advertisements.

6. The method of claim 1, wherein the plurality of sources comprises a plurality of disparate sources.

7. The method of claim 1, wherein processing the raw data comprises applying an extract-transform-load (ETL) process to the raw data.

8. The method of claim 1, wherein the machine learning analysis is applied by a data analytics engine.

9. A system for providing a data services platform, the system comprising:
a processor;
a network interface;
a memory containing computer-readable instructions for execution by said processor, said instructions comprising:
a process utility module configured to process raw data from a plurality of sources over a communications network via the network interface;
a data store configured to store the processed data;
a data analytics engine configured to apply a machine learning analysis based on one or more sets of rules to the processed data; and
a prediction engine configured to generate one or more prediction values based on the machine learning analysis.

10. The system of claim 9, wherein the raw data contains insufficient or inadequate user data for a target audience, and wherein the data analytics engine is configured to analyze the processed data in order to determine insights into user references for said target audience.

11. The system of claim 10, wherein the data analytics engine is configured to apply a fuzzy matching process to determine the insights based on the processed data.

12. The system of claim 10, wherein the raw data contains insufficient or inadequate user data for determining product or item recommendations for one or more users or customers, and wherein the data analytics engine is configured to analyze the processed data in order to determine the product or item recommendations.

13. The system of claim 11, wherein the process utility module is configured to apply an extract-transform-load (ETL) process on the raw data.

14. The system of claim 11, wherein the data store is a master repository data store.

15. The system of claim 9, wherein the raw data comprises at least one of targeting data, individual user data, metrics data, and advertisement metadata.

16. The system of claim 9, further comprising a digital dashboard for displaying one or more recommendations based on the one or more prediction values.

17. The system of claim 16, wherein the one or more recommendations relate to at least one of: a target audience, target demographic characteristics, a delivery method of advertisements, advertisement content, items, and product type.

18. A non-transitory computer-readable storage medium having stored thereon computer-executable instructions that, when executed by a processor, cause the processor to perform the method of claim 1.
